(19) United States
(12) Patent Application Publication
(10) Pub. No.: US 2007/0216826 A1
(43) Pub. Date: Sep. 20, 2007

(54) CONTAINER MEMBER, METHOD OF MANUFACTURING CONTAINER MEMBER, AND FLAT PANEL DISPLAY USING CONTAINER MEMBER

(76) Inventors: Jong Nam Lee, Angyang-Si (KR); Dong Cheol Kim, Suwon-si (KR); Kuk Young Cho, Seongnam-Si (KR); Jeong Min Seo, Seongnam-Si (KR)

Correspondence Address: Frank Chau, Esq.;F. CHAU & ASSOCIATES, LLC, 130 Woodbury Road, Woodbury, NY, 11797, US

(21) Appl. No.: 11/687,138

(22) Filed: Mar. 16, 2007

(30) Foreign Application Priority Data
Mar. 20, 2006 (KR) 10-2006-0025268

(51) Int. Cl. G02F 1/1333

(52) U.S. Cl. 349/58

(57) ABSTRACT

A container member, a method of manufacturing the container member, and a flat panel display using the container member. In order to protect a flat display panel from external impact, at least one sidewall of a lower chassis is folded into two or more parts to effectively absorb the external impact. As a result, strength of a flat panel display is increased without changing the material of the container member or increasing the external size.

### CROSS-REFERENCE TO RELATED APPLICATION

The present application claims priority to Korean Patent Application No. 2006-0025268 filed on Mar. 20, 2006, the contents of which are incorporated herein by reference in their entirety.

### BACKGROUND OF THE INVENTION

1. Technical Field

The present disclosure relates to a container member, to a method of manufacturing the container member, and to a flat panel display using the container member. More specifically, the present disclosure relates to a container member that can effectively absorb external impact in order to protect the flat display panel, to a method of manufacturing the container member, and to a flat panel display using the container member.

2. Discussion of the Related Art

Flat panel displays, such as liquid crystal displays (LCDs), organic light emitting diodes (OLEDs), and plasma displays, have a small size, a light weight, and a large screen, when compared with a cathode ray tube (CRT) display.

Such a flat panel display can be manufactured by forming a plurality of pixels on a transparent substrate and mounting a driving chip for driving the pixels and by mounting a flexible printed circuit board (FPC) for supplying a predetermined signal to the driving chip on one side of the transparent substrate.

The flat panel displays are used in small-sized apparatuses, such as cellular phones, personal digital assistants (PDAs), and portable multimedia players (PMPs), as well as TV sets or computer monitors.

The flat panel display can be inserted as a module into, for example, a cellular phone, a PDA, or a PMP. However, a portable apparatus manufactured in this way can be easily damaged due to external impact.

FIG. 1 is a graph illustrating the strength of impact stress caused by dropping of a flat panel display according to the related art. Referring to the graph, the maximum effective stress of the impact caused by dropping (about 263.6 MPs), may break a panel of the flat panel display.

### SUMMARY OF THE INVENTION

Embodiments of the invention provide a container member which is made by folding a sidewall of a lower chassis for containing a flat display panel and forming a mold frame on the lower chassis by injection molding. The resulting container member can effectively absorb external impact in order to protect the flat display panel from the external impact. Embodiments of the invention also provide a method of manufacturing the container member, and a flat panel display using the container member.

A flat panel display, according to an embodiment of the present invention, includes a flat display panel, and a container member that contains the flat display panel. The container member includes a lower chassis having a bottom and sidewalls that are formed along the edges of the bottom. At least one sidewall is folded into a plurality of parts. A mold frame is connected with the lower chassis.

The sidewalls may be folded toward the inside the lower chassis.

Further, the flat display panel may be a liquid crystal display panel, and the flat panel display may further include a backlight unit that radiates light onto the liquid crystal display panel. The backlight unit can be disposed between the liquid crystal display panel and the lower chassis.

The mold frame may be formed on the lower chassis by injection molding.

In addition, through holes may be formed in an inside part of the inwardly folded sidewall and protrusions may be formed on the mold frame to correspond to the through holes.

The mold frame is formed to cover outside of a folding part of the at least one sidewall, and the folding part is a folded region of the at least one sidewall.

A first end of the sidewall is connected with the bottom, a second end of the sidewall is positioned apart from the bottom, and the mold frame is disposed in the space between the second end of the sidewall and the bottom.

The mold frame comprises a hole, a first support part and a second support part, and a light source of the backlight unit is disposed in the hole, the first support part supports an optical film and the second support supports the liquid crystal display panel.

A container member, according to an embodiment of the present invention, includes a lower chassis including a bottom and sidewalls that are formed along the edges of the bottom, wherein at least one sidewall is folded into a plurality of parts, and a mold frame connected with the lower chassis.

The sidewalls may be folded toward the inside the lower chassis.

The mold frame may be formed on the lower chassis by injection molding.

A method of manufacturing a container member for a flat panel display, according to an embodiment of the present invention, includes folding at least one sidewall of a lower chassis into a plurality of parts; and forming a mold frame on the lower chassis by injection molding.

The folding of the at least one sidewall of the lower chassis may be accomplished by folding the sidewall to the inside of the lower chassis.

Through holes may be formed in an inside part of the plurality of parts of the at least one folded sidewall.

### BRIEF DESCRIPTION OF THE DRAWINGS

Exemplary embodiments of the present invention can be understood in more detail from the following descriptions taken in conjunction with the attached drawings in which:

FIG. 1 is a graph illustrating impact stress caused by dropping of a flat panel display according to the related art.

FIG. 2 is an exploded perspective view of a flat panel display according to an embodiment of the invention.

FIG. 3 is a perspective view of a mold frame and lower chassis according to an embodiment of the invention.

FIG. 4 is a cross-sectional view taken along the line A-A of FIG. 3.

FIG. 5 is a graph illustrating the strength of impact stress caused by dropping of a flat panel display according to an embodiment of the invention.

FIG. 6 is a perspective view of a mold frame and a lower chassis according to an embodiment of the invention.

FIG. 7 is a cross-sectional view taken along the line B-B of FIG. 6.

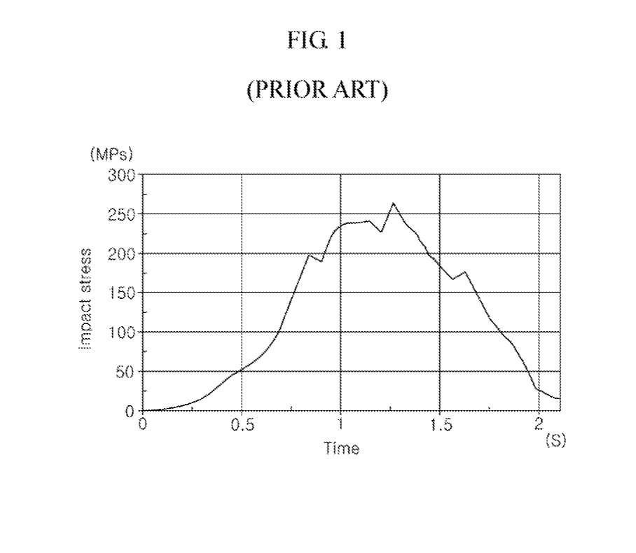

### DESCRIPTION OF EXEMPLARY EMBODIMENTS

Hereinafter, exemplary embodiments of the invention will be described in more detail with reference to the accompanying drawings. However, the invention is not limited to the following embodiments, but various modifications and changes can be made without departing from the scope and spirit of the invention. In the drawings, the same reference numerals can denote the same or similar components.

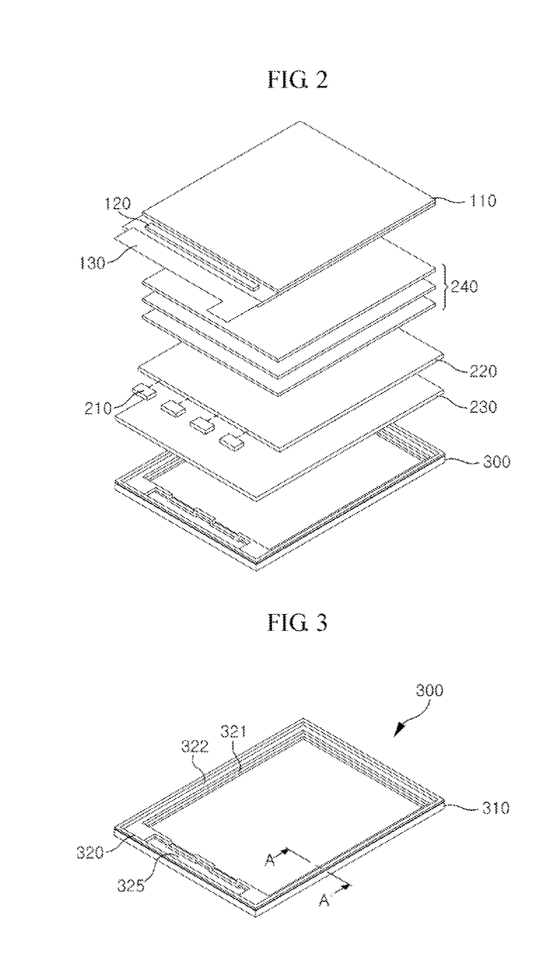

FIG. 2 is an exploded perspective view of a flat display according to an embodiment of the invention. A liquid crystal display including a liquid crystal display panel will be described as an example of the flat panel display, but the invention is not limited thereto.

Referring to FIG. 2, a liquid crystal display according to an embodiment of the invention includes a liquid crystal display panel 110, a backlight unit, and a container member 300.

The liquid crystal display panel 110 includes a thin film transistor substrate having a plurality of thin film transistors and a plurality of pixel electrodes formed thereon, a color filter substrate which faces the thin film transistor substrate and has a common electrode formed thereon, a liquid crystal layer formed of liquid crystal between the thin film transistor substrate and the color filter substrate, a driving chip 120 for driving the thin film transistors, and a flexible printed circuit board 130 for supplying signals from the outside to the driving chip 120. The liquid crystal may be injected between the thin film transistor substrate and the color filter substrate to form the liquid crystal layer.

The driving chip 120 of the liquid crystal display panel 110 applies a predetermined electric field to the electrodes formed on the thin film transistor substrate and the color filter substrate. The electric field changes the alignment of the liquid crystal between the thin film transistor substrate and the color filter substrate. When the alignment of the liquid crystal is changed, the transmittance of the liquid crystal layer is changed, whereby a desired image is obtained.

The backlight unit includes a plurality of light sources 210 for emitting light, a light guiding plate 220 connected to the light source 210, a reflective sheet 230 provided on the lower side of the light guiding plate 220, and an optical sheet 240 provided on the upper side of the light guiding plate 220.

The light source 210 radiates light onto a side surface of the light guiding plate 220. A light emitting diode or a cold cathode fluorescent lamp (not shown) may be used as the light source 210.

The light guiding plate 220 changes light having an optical distribution of a point light source, generated by the light sources 210, to light having an optical distribution of a surface light source. A wedge-type plate or a parallel-plate-type plate may be used as the light guiding plate 220.

The reflective film 230 is composed of a plate having high reflectance. As shown in FIG. 2, the reflective film 230 is formed in a flat shape. However, the reflective film 230 may be formed to have an irregular shape which has a reference reflective surface and a plurality of protrusions. Each of the plurality of protrusions may have a triangular cross-sectional shape and protrude from the reference reflective surface.

the optical sheet 240 is disposed on the upper side of the light guiding plate 220 so as to uniformly distribute the light emitted from the light guiding plate 220.

The container member 300 contains the backlight unit and the liquid crystal display panel.

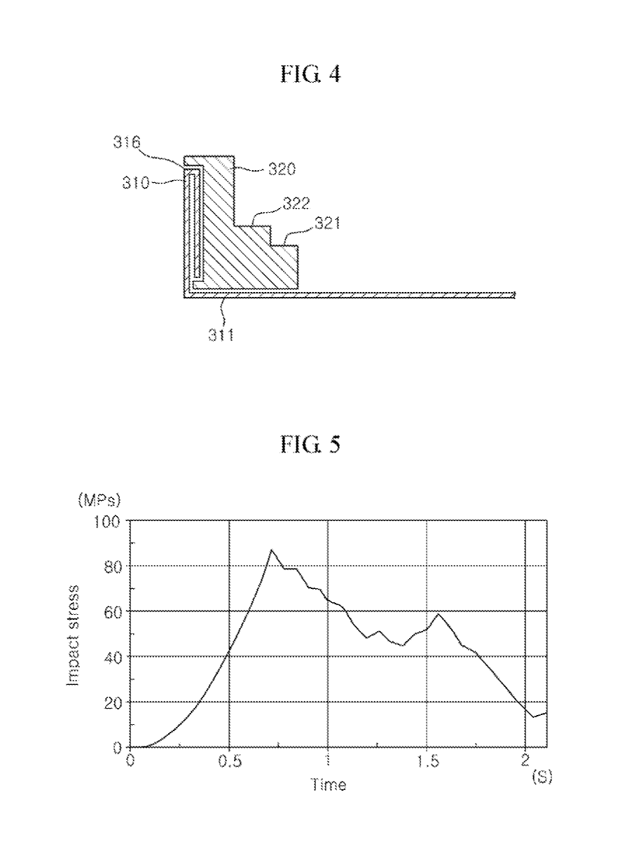

Referring to FIGS. 3 and 4, the container member according to an embodiment of the invention will be described in more detail.

FIG. 3 is a perspective view of the container member 300 shown in FIG. 2, and FIG. 4 is a cross-sectional view of the container member 30 shown in FIG. 3 taken along the line A-A.

Referring to FIG. 3, the container member 300 includes a lower chassis 310 and a mold frame 320.

The mold frame 320 is connected with the lower chassis 310 to contain the backlight unit. The liquid crystal display panel 110 is arranged on the backlight unit. An upper chassis to be connected with the lower chassis 310 may be disposed on the upper side of the liquid crystal display panel 110. The mold frame 320 comprises a hole 325, a first support part 321 and a second support part 322. The plurality of light sources 210 are disposed in the hole 325, the first support part 321 supports optical films such as the light guiding plate 220 and the optical sheet 240, and the second support 322 supports the liquid crystal display panel 110.

Referring FIG. 4, the lower chassis 310 comprises a bottom 311 and sidewalls 315 extended from the edge of the bottom 311. The sidewalls 315 of the lower chassis 310 are folded into two parts at the inside portion of the lower chassis. The mold frame 320 is formed along the inside of the sidewall of the lower chassis 310. The mold frame 320 is formed to cover the outside of a folding part 316 of sidewalls 315. The folding part 316 is a folded region of the sidewall. One end of the sidewall 315 is connected with the bottom 311, and the other end of the sidewall 315 is positioned apart from the bottom 311. The mold frame is disposed in the space between the other end of the sidewall 315 and the bottom 311.

In order to manufacture the container member 300, for example, the lower chassis 310 is formed first and then the mold frame 320 is formed along the inside of the sidewalls by injection molding.

In this embodiment, the sidewalls of the lower chassis 310 are folded into two equal or substantially equal parts. However, the sidewalls of the lower chassis 310 may be folded into three or more parts. Further, in this embodiment, all the sidewalls of the lower chassis 310 are folded into two parts. Alternatively, less than all of the sidewalls of the lower chassis 310 can be folded into two parts, whereby some of the sidewalls are not folded and/or some of the sidewalls are folded into more than two parts. For example, only the longer sidewalls of the lower chassis 310 may be folded into two parts, or only the shorter sidewalls of the lower chassis 310 may be folded into two parts. In another example, one of the longer sidewalls or one of the shorter sidewalls may be folded into two parts.

Hooks may optionally be provided on the sidewalls of the lower chassis 310 and protrusions may be formed on the mold frame 320 to correspond to the hooks.

The mold frame 320 is formed inside the lower chassis 310 by injection molding. Alternatively, the mold frame 320 may be independently formed and connected to the lower chassis 310.

When a drop impact analysis is carried out on the container member 300 having the above-mentioned structure, the result of the impact stress caused by dropping is calculated with the maximum effective stress of 84.4 MPs, as shown in FIG. 5. Therefore, the maximum effective stress of the impact caused by dropping of the flat panel display according to this embodiment of the invention is decreased by 65% as compared with the related art in which the maximum effective stress of impact caused by dropping of a flat panel display is 263.6 MPs.

In a structure in which hooks are formed on the lower chassis, when the hooks are buckled, the liquid crystal panel can become stressed. However, in the structure of the present embodiments, in which the sidewalls of the lower chassis are folded, since buckling of the lower chassis is reduced, the impact stress is also reduced.

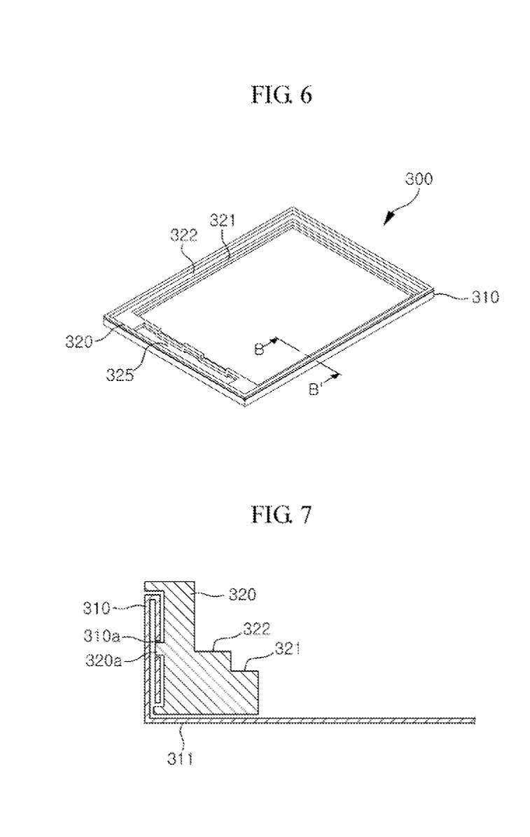

Next, a container member 300 according to an embodiment of the invention will be described with reference to FIGS. 6 and 7.

The container member according to this embodiment illustrated in FIGS. 6 and 7 includes through holes formed at the inside of the sidewalls of a lower chassis.

FIG. 6 is a perspective view of the container member 300 according to this embodiment, and FIG. 7 is a cross-sectional view of the container member 300 shown in FIG. 6 taken along the line B-B.

Referring to FIG. 6, the container member 300 includes a lower chassis 310 and a mold frame 320.

The mold frame 320 is connected with the lower chassis 310 to contain the backlight unit. The liquid crystal display panel 110 is disposed on the backlight unit. An upper chassis may be positioned on the upper side of the liquid crystal display panel 110 to be connected with the lower chassis 310. The mold frame 320 comprises a hole 325, a first support part 321 and a second support part 322. The plurality of light sources 210 are disposed in the hole 325, the first support part 321 supports optical films such as the light guiding plate 220 and the optical sheet 240, and the second support 322 supports the liquid crystal display panel 110.

Referring FIG. 7, the lower chassis 310 comprises a bottom 311 and sidewalls 315 extended from the edge of the bottom 311. The sidewalls of the lower chassis 310 are folded into two parts at the inside portion of the lower chassis. The mold frame 320 is formed along the inside of the sidewalls of the lower chassis 310.

In order to manufacture the container member 300, for example, the lower chassis 310 is formed first and then the mold frame 320 is formed along the inside of the sidewall by injection molding.

The mold frame 320 is formed to cover the outside of a folding part 316 of sidewalls 315. The folding part 316 is a folded region of the sidewall. One end of the sidewall 315 is connected with the bottom 311, and the other end of the sidewall 315 is positioned apart from the bottom 311. The mold frame is disposed in the space between the other end of the sidewall 315 and the bottom 311.

Through holes 310a are formed in the inside part of the folded sidewalls of the lower chassis 310 before the mold frame 320 is formed by injection molding. In addition holes may be formed in a non-folded sidewall to before the mold frame 320 is formed by injection molding.

Therefore, when the mold frame 320 is formed by injection molding, protrusions 320a are formed on the mold frame 320 to correspond to the through holes 310a. Therefore, in the container member according to this embodiment, the lower chassis 310 and the mold frame 320 are strongly connected with each other to further protect the liquid crystal display panel.

In the embodiments of the invention, the liquid crystal display is exemplified. However, the invention may be applied to an OLED or other flat panel displays, such as a plasma display.

In a flat panel display, in order to protect the flat display panel from external impact, the sidewall of the lower chassis is folded into two or more parts to effectively absorb external impact. Further, the flat panel display according to the embodiments of the invention can improve the strength without changing the material of the container member or increasing the external size.

Although illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A flat panel display comprising:
a flat display panel; and
a container member,
wherein the container member includes:
a lower chassis having a bottom and sidewalls formed along edges of the bottom, wherein at least one sidewall is folded into a plurality of parts; and
a mold frame connected with the lower chassis.

2. The flat panel display of claim 1,
wherein the at least one sidewall is folded toward an inside of the lower chassis.

3. The flat panel display of claim 1,
wherein the flat display panel is a liquid crystal display panel, and
the flat panel display further includes a backlight unit disposed between the liquid crystal display panel and the lower chassis.

4. The flat panel display of claim 1,
wherein the mold frame is formed on the lower chassis by injection molding.

5. The flat panel display of claim 2,
wherein through-holes are formed in an inside part of the plurality of parts of the folded sidewall, and protrusions are formed on the mold frame to correspond to the through-holes.

6. The flat panel display of claim 1,
wherein the mold frame is formed to cover outside of a folding part of the at least
one sidewall, and the folding part is a folded region of the at least one sidewall.

7. The flat panel display of claim 1,
wherein a first end of the sidewall is connected with the bottom, a second end of the sidewall is positioned apart from the bottom, and the mold frame is disposed in the space between the second end of the sidewall and the bottom.

8. The flat panel display of claim 3,
wherein the mold frame comprises a hole, a first support part and a second support part, and
a light source of the backlight unit is disposed in the hole, the first support part supports an optical film and the second support supports the liquid crystal display panel.

9. A container member for a flat panel display, comprising:
a lower chassis including a bottom and sidewalls formed along edges of the bottom, wherein at least one sidewall is folded into a plurality of parts; and
a mold frame connected with the lower chassis.

10. The container member for a flat panel display of claim 9,
wherein the at least one sidewall is folded toward an inside of the lower chassis.

11. The container member for a flat panel display of claim 9,
wherein the mold frame is formed on the lower chassis by injection molding.

12. A method of manufacturing a container member for a flat panel display, comprising:
folding at least one sidewall of a lower chassis into a plurality of parts; and
forming a mold frame on the lower chassis by injection molding.

13. The method of claim 12,
wherein the at least one sidewall is folded to the inside of the lower chassis.

14. The method of manufacturing a container member for a flat panel display of claim 13, further comprising:
forming through holes in an inside part of the plurality of parts of the folded sidewall of the lower chassis.
